(19) United States
(12) Patent Application Publication
(10) Pub. No.: US 2026/0063551 A1
(43) Pub. Date: Mar. 5, 2026

(54) Optical Imaging System

(71) Applicant: James Jiang, Long Valley, NJ (US)

(72) Inventor: James Jiang, Long Valley, NJ (US)

(21) Appl. No.: 18/822,810

(22) Filed: Sep. 3, 2024

(51) Int. Cl. G01N 21/64

(52) U.S. Cl. CPC G01N 21/6408; G01N 21/6402; G01N 21/6458

(57) ABSTRACT

This invention presents a frequency-domain fluorescence lifetime imaging system, enhancing capabilities with a spatial beam attenuator and pinhole beam splitter. The spatial beam attenuator reshapes any beam into a circular Gaussian beam profile, being compact, cost-effective, with low loss and back reflection. Using digital printing technology, a thin optical film is deposited onto an optical substrate for precise local attenuation of the beam in either transmission or reflection mode. The pinhole beam splitter consists of an optical beam splitter with an active region the size of a pinhole, positioned near the beam's focus, which directs focused light into two paths based on acceptance or rejection by the pinhole. This configuration allows for two detectors to collect photons from both paths concurrently, facilitating dual-mode imaging. Consequently, the system can generate both confocal and conventional non-confocal laser scanning fluorescence lifetime images of the sample at the same time.

### FIELD OF THE INVENTION

This invention relates to the field of optical imaging, specifically Fluorescence Lifetime Imaging Microscopy (FLIM). It aims to enhance the system's optical resolution, functionality, and imaging speed without significantly increasing overall costs.

### BACKGROUND

Fluorescence lifetime imaging microscopy is an optical imaging technique that measures the time it takes for a fluorophore to return to its ground state after being excited by a light source. Fluorophores are molecules that can absorb light at one wavelength and emit light at a longer wavelength. The fluorescence lifetime is the average time a molecule spends in an excited state before returning to its ground state through emission of a photon. FLIM measures the distribution of fluorescence lifetimes across each sample location to create an image, providing detailed insights into the molecular environment and interactions. FLIM has many applications in biological and medical research, including the study of molecular interactions, investigation of cellular microenvironments, and analysis of tissue metabolic states. Additionally, FLIM can be combined with other microscopy techniques, such as confocal or two-photon microscopy, to obtain more comprehensive imaging data about the samples.

Compared to traditional fluorescence microscopy based on acquiring the intensity and wavelength dependent fluorescence signals from the samples, FLIM focuses on the time component of fluorescence emission and offer several distinctive advantages: 1) FLIM provides quantitative information about the fluorescence lifetime of fluorophores, which is independent of fluorophore concentration and excitation intensity. This makes FLIM more robust in situations where sample conditions may vary, and allows for more accurate and reproducible measurements. 2) The fluorescence lifetime is sensitive to the local environment of the fluorophore, such as pH, temperature, molecular interactions and cell metabolism states. Therefore, FLIM can provide insights into the microenvironment of fluorophores within a sample, and enable the study of molecular dynamics and interactions, as well as cellular functions. 3) FLIM can help discriminate between different fluorophores with overlapping emission spectra based on their distinct fluorescence lifetimes. This is particularly useful in situations where traditional intensity-based imaging might struggle to distinguish between closely spaced fluorophores. 4) Since FLIM relies on the measurement of the time delay between excitation and emission rather than the total emitted intensity, it is less susceptible to photobleaching (the permanent loss of fluorescence due to prolonged exposure to light) and phototoxicity (damage to biological specimens caused by exposure to light) in the samples.

Time-domain FLIM (TD-FLIM) and Frequency-domain FLIM (FD-FLIM) are two different approaches for performing Fluorescence Lifetime Imaging Microscopy, each involving different technical methods for fluorescence lifetime measurement and data processing.

In TD-FLIM, a pulsed light source excites the fluorophores, and the time decay curve of the emitted fluorescence photons, typically measured on a nanosecond time scale, is recorded. This allows for the calculation of the fluorescence lifetime. TD-FLIM provides high temporal resolution to allow accurate measurements of fluorescence lifetimes for studying fast dynamic processes in biological samples. TD-FLIM is well-suited for situations where the fluorescence decay can be described by multiple exponential components, which allows for the identification and quantification of different fluorescent species with distinct lifetime values. One of the main drawbacks of TD-FLIM is its relatively slow acquisition speed. The need to record the entire fluorescence decay curve for each pixel in the image can lead to longer acquisition times, limiting its application in real-time imaging. Implementing TD-FLIM requires specialized and complex instrumentation, including pulsed lasers and time-correlated single-photon counting (TCSPC) systems. This can make TD-FLIM setups more expensive and technically challenging compared to other FLIM techniques. Analyzing TD-FLIM data can be computationally intensive, requiring sophisticated algorithms for curve fitting and lifetime extraction.

In FD-FLIM, the intensity of the excitation light is modulated at a high frequency to measure the phase shift and modulation ratio of the emitted fluorescence signals. These parameters are then used to determine the fluorescence lifetime. FD-FLIM generally offers faster measurement speeds than time-domain FLIM because it can rapidly extract lifetime information without recording the complete decay curve for each pixel. This method allows for simpler and less expensive setups compared to time-domain FLIM, due to the use of modulated light sources and phase-sensitive detection which simplify the instrumentation. However, FD-FLIM faces challenges in accurately characterizing fluorescence decays with multiple exponential components, making it better suited for samples with relatively simple decay profiles. Although FD-FLIM setups are generally simpler than TD-FLIM setups, they are still more complex than traditional intensity-based fluorescence microscopes. This complexity arises from the need for specialized instruments, including high-frequency modulated light sources, phase-sensitive detectors, sophisticated electronic synchronization schemes, and advanced software processing algorithms.

A confocal laser scanning fluorescence microscope is an advanced optical imaging tool used in biology and materials science to obtain high-resolution, three-dimensional images of fluorescently labeled specimens. FLIM can be seamlessly integrated with confocal fluorescence microscopy to enhance insights into both the temporal and spatial aspects of fluorescence. While confocal microscopy provides optical sectioning, reduces background fluorescence, and improves signal-to-noise ratio (SNR) using a pinhole aperture, FLIM focuses on fluorophore lifetime rather than intensity, providing a unique contrast mechanism and revealing subtle changes in the molecular environment. This integration allows for precise localization of fluorescence intensity and accurate lifetime measurements, particularly in three-dimensional samples. It facilitates the study of dynamic biological processes, such as protein-protein interactions and intracellular signaling, offering researchers a comprehensive tool for investigating molecular events with spatial and temporal precision. The FLIM-integrated confocal scanning microscope benefits from a high-quality Gaussian-shaped beam generated by a cost-effective laser used as the light source in the system.

The Gaussian beam, also known as TEM₀₀ mode, is a laser beam characterized by its cross-sectional Gaussian intensity distribution, symmetric about the central axis. This profile offers significant benefits for high-resolution imaging and optical sectioning. First, the rapid decrease in intensity towards the edges of the beam confines excitation to a precise, well-defined volume, enhancing both lateral and axial resolution. Second, the beam efficiently illuminates the focal plane while minimizing light exposure to surrounding areas, thereby reducing photobleaching and phototoxic effects on the specimen. Third, the beam's properties complement the use of a pinhole aperture, which blocks out-of-focus light and improves the SNR by ensuring that only light from the focal plane contributes to the image.

Diode lasers, also known as semiconductor lasers or laser diodes, are cost-effective due to their mass production, simple construction, and compact size. They are ideal light sources for confocal fluorescence microscopy because of their excellent monochromaticity, coherence, and high intensity. However, a significant limitation is their elliptical native beam shape, where the intensity distribution is elongated along one axis compared to the perpendicular axis. This elliptical beam profile results from the anisotropic gain within the laser cavity, influenced by the shape and dimensions of the semiconductor gain medium, which preferentially amplifies light in certain directions. To address this, various beam shaping techniques below have been developed to convert the elliptical beam profile into a more uniform Gaussian profile for demanding applications.
1. A small optical aperture, such as a pinhole or a single mode fiber, is placed at the focal point of a lens in the beam path, acting as a spatial filter. This setup allows a well-defined portion of the beam to pass through, effectively suppressing higher-order modes and creating a symmetrical, bell-shaped intensity distribution characteristic of a Gaussian beam after the beam is re-collimated at the aperture's output. However, this configuration results in significant back reflection toward the source because many photons are rejected at the lens's focal plane. This back reflection can cause instabilities in the laser's output intensity unless an optical isolator is used.
2. An anamorphic prism pair or cylindrical lenses can act as a beam expander along a single axis of the incoming beam, without altering the beam size in the perpendicular axis. When correctly positioned in the optical path, these optical elements can transform elliptical beams into nearly circular beams.
3. An optical beam expander is first used to convert an elliptical beam into a flat-top beam for the center region of the beam first. Next, an optical apodization filter, which has an optical attenuation profile symmetric about the center of the filter, is used to convert the flat-top beam into Gaussian shaped beam. Like using an anamorphic prism pair or cylindrical lenses, incorporating a beam expander requires integrating bulky optics into the system's optical path.
4. A spatial light modulator can dynamically manipulate the phase or amplitude of light. By designing and loading a computer-generated pattern onto the modulator, an elliptical beam can be transformed into a Gaussian shape. However, spatial light modulators are active components and are typically expensive due to their sophisticated components, such as liquid crystal arrays, MEMS mirrors, or digital micromirror devices (DMDs).

Another limitation of confocal laser-scanning microscopes is the substantial signal loss at the pinhole, a crucial component located at the image plane between the objective lens and the detector. The pinhole allows only light from the sample's focal plane to contribute to the final image while blocking out-of-focus light from other depth planes. This selective filtering enhances resolution, contrast, and provides optical sectioning capability. However, when imaging samples with weak fluorescence signals, the limited light passage through the pinhole can reduce the SNR, making it difficult to distinguish weak signals from background noise. To mitigate this issue, longer exposure times may be required, but this increases the risk of photobleaching or phototoxicity, especially in live specimens. Alternatives such as increasing the pinhole size or removing it entirely may boost signal strength but at the cost of diminished optical sectioning capabilities.

This invention addresses the challenges mentioned above in confocal fluorescence microscopy. First, it uses a specially designed spatial beam attenuator to convert a laser beam with a non-Gaussian intensity profile into a Gaussian intensity profile for sample illumination. Second, it introduces a unique optical device called a pinhole beam splitter to replace the conventional pinhole. The pinhole beam splitter allows two detectors to simultaneously collect photons that are accepted and rejected by the pinhole, enabling a dual imaging mode. This dual mode allows the system to produce both confocal images and conventional laser scanning images of the sample simultaneously.

### PRIOR ARTS

A paper, “Low-cost, frequency-domain, fluorescence lifetime confocal microscopy”, Booth et al., Journal of Microscopy, vol. 214, pp. 36, 2003, teaches a frequency domain FLIM imaging system using a modulated diode laser and radio frequency demodulation techniques to obtain the phase and modulation information in the frequency domain to calculate the fluorescence lifetime images of the sample. In that system, to achieve a clean Gaussian mode shape for sample illumination, the laser beam was passed through beam conditioning optics, comprising an anamorphic prism pair and an astigmatic correction lens, before being focused through a pinhole. A significant disadvantage of this beam shaping approach is that focusing the laser beam through a pinhole can cause unwanted back-reflected light towards the incoming beam direction, especially when a considerable portion of the optical power is rejected by the pinhole at the focus of the lens. These back reflections can disrupt the laser's operation, making it difficult to maintain stable intensity and phase modulation. Optical isolators can be a solution to this issue, but they are bulky and expensive for visible wavelengths.

A patent, “Apparatus and method for all-solid-state fluorescence lifetime imaging”, U.S. Pat. No. 7,508,505 B2, describes a frequency domain FLIM imaging system designed for wide-field microscopy. This system uses a CCD/CMOS type lock-in imager as a phase-sensitive detector, synchronized with a modulated light source to measure sample lifetimes. In this setup, a lens is used to collimate light from a laser or LED for sample illumination without any additional beam treatment. In a wide-field microscope, the entire specimen is uniformly illuminated with a broad beam of light, and all parts within the focal plane contribute to the image. However, without a confocal pinhole for optical sectioning in depth, light from out-of-focus planes can enter the detector, resulting in lower-resolution and lower-contrast images, especially in thicker samples.

This system uses modulated diode lasers and software-based Fast Fourier Transform (FFT) to generate lifetime images of samples using the frequency domain method on a confocal microscope. In this setup, the laser output beam passes through a circular aperture (a 0.3 mm diameter pinhole, Thorlabs P300D) to convert its shape from elliptical to circular for focusing on the sample. However, this simple beam shaping process is not ideal because after cropping the beam, the abrupt change in beam intensity distribution along the long axis causes diffraction ring patterns, compromising the focused spot size and optical resolution of the microscope. The system is calibrated by measuring standard dyes such as coumarin-6 and fluorescein. Preparing these reference dye solutions requires trained lab skills and specialized tools. Additionally, the temperature and pH of the solutions must be precisely controlled to produce the most accurate calibration results.

A paper, “Confocal fluorescence-lifetime single-molecule localization microscopy”, Thiele et al., ACS Nano, vol. 14, pp. 14190, 2020, teaches a time-domain FLIM system built into a scanning laser confocal microscope for single-molecule localization microscopy. A book chapter, “Fluorescence lifetime imaging ophthalmoscopy (FLIO)”, Bernstein et al., High Resolution Imaging in Microscopy and Ophthalmology, pp. 217, 2019, also teaches a time domain fluorescence lifetime imaging module integrated into a Scanning Laser Ophthalmoscopy (SLO) system. A paper “Direct frequency domain fluorescence lifetime imaging using field programmable gate arrays for real time processing”, Serafino et al., Review of Scientific Instruments, vol. 91, pp 33708, 2020, teaches a frequency domain FLIM system using a FPGA to synchronize source modulation and emission digitization. In all three of the above systems, a single mode fiber is used to deliver light from the source to the sample. An important function of the single mode fiber is to act as a spatial filter, generating a Gaussian-shaped beam for sample illumination. This approach requires a bulky setup that includes a single-mode fiber and two additional lenses to couple light in and out of the fiber. Due to the very small core diameter of single-mode fibers, typically just a few micrometers, even slight misalignment can cause significant changes in output power, making it challenging to maintain stable power over time. Furthermore, because the input facet of the single-mode fiber is positioned at the lens's focal point, there is a high risk of rejected photons being back-reflected toward the source. Without proper optical isolation, this back reflection can interfere with laser operations, causing severe power fluctuations and frequency instabilities.

A paper, “Direct frequency domain fluorescence lifetime imaging using simultaneous ultraviolet and visible excitation”, Serafino et al., Biomedical Optics Express, vol. 14, pp. 1608, 2023, teaches a frequency domain FLIM system that is capable of multiple excitation and detection channels. In this system, several 3.5 μm core single-mode fibers are used to deliver light from diode lasers to the laser scanning microscope, while multiple 200 μm core multimode fibers are used to couple the fluorescence photons to APD detectors. Although the large core of multimode fibers increases the photon collection efficiency for the APDs, a significant drawback is that signal photons can take different paths within a multimode fiber, leading to ambiguity in photon arrival time and decreased accuracy in the measured fluorescence lifetime. This occurs because, in multimode fibers, light can travel through various paths or modes, including direct paths, zigzag paths, or other complex trajectories within the core. This system works only when the multi-mode fibers are kept very short and remain fixed in place.

A paper, “GPU acceleration of time-domain fluorescence lifetime imaging”, Wu et al., Journal of Biomedical Optics, vol. 21, pp. 017001, 2016, teaches the implementation and optimization of time-domain FLIM system data processing algorithms on GPUs, achieving a speed improvement of over 20 times. The system uses a femtosecond Ti:Sapphire laser with a Gaussian output beam shape for fluorescence excitation, which eliminates the need for additional beam-shaping optics. However, the wide adoption of commercial Ti:Sapphire lasers into other imaging systems is significantly hindered by their high cost and complexity. In this study, GPU-based data processing algorithms were specifically developed for processing fluorescence signals using the time-domain FLIM method, distinct from the algorithms used in frequency-domain FLIM data processing.

A commercial product, the “Optical Apodizing Filters” produced by Reynard Corporation in San Clemente, California, are radial graduated neutral density filters. These filters feature a transparent center with optical attenuation gradually increasing towards the edges. They are specifically designed to transform a flat-top beam profile into a near-Gaussian beam profile. To utilize this type of filter for converting an elliptical beam shape into a Gaussian beam shape, the elliptical beam must first be transformed into a flat-top shape. This transformation is typically achieved using a beam expander, which expands the center region of the elliptical beam to make it more uniform in power. However, incorporating a beam expander into every laser setup can significantly increase both the system's overall size and cost, and introduce additional losses in the beam conversion process.

A paper, “Fabrication of apodized apertures for laser beam attenuation”, Hee, Optics and Laser Technology, vol. 5, pp. 75, 1975, teaches a method to manufacture the radial graduated ND filter. This technique involves designing an opaque mask with varying opening angles at different radius. During production, as the mask rotates at a constant speed, either the exposure time of photo-sensitive glass plates or the thickness of the vapor-deposited metal film can be continuously controlled. However, a limitation of this method is that it can only produce optical attenuation filters with circular symmetry. It cannot be used to directly convert laser beams with elliptical shapes or other non-circularly symmetric forms into a circular Gaussian shape.

### SUMMARY

This invention discloses a frequency domain fluorescence lifetime imaging system that utilizes a “spatial beam attenuator” and a “pinhole beam splitter” to enhance imaging performance and functionality. The spatial beam attenuator instantly converts a beam with any intensity profile into a beam with Gaussian intensity profile, and is a compact, low-cost optical device with low optical insertion loss and back reflection. It is ideal for applications like scanning laser confocal fluorescence microscopy, where size, cost, and performance are crucial. The spatial beam attenuator eliminates the need for bulky conventional beam shaping optics, such as single-mode fibers, prism pairs, and multiple lenses, and reduces the complexity and cost associated with advanced spatial light modulators. Utilizing digital printing technology, a thin film of optical absorptive or reflective material is precisely printed or deposited onto an optical substrate to provide localized attenuation of the optical beam passing through the device in either transmission or reflection mode. The device is therefore capable of transforming an arbitrary input beam shape into a circular Gaussian shape. The beam transfer function is custom designed and permanently fabricated onto the spatial beam attenuator and cannot be altered after production. Unlike the spatial beam modulator, the spatial beam attenuator is a passive optical device that does not require driving electronics or a power supply and is not programmable.

The pinhole beam splitter is a novel optical device that can divide an incoming focused beam into two spatial directions when placed at the beam's focal point. This is accomplished by precisely manufacturing an optical beam splitter with the diameter of an optical pinhole, ranging from a few micrometers to a few tens of micrometers. Positioned at the focal point of the focused beam and oriented at 45 degrees to the incoming beam, the pinhole beam splitter directs the light within its radius in one direction, effectively simulating a traditional pinhole. Simultaneously, the remaining portion of the beam, outside the pinhole radius, is directed in another direction, allowing the collection of all the light rejected by the pinhole. When this pinhole beam splitter replaces the conventional pinhole in a confocal fluorescence microscope, it enables the use of two optical detectors to measure the signal photons passing through the pinhole and those rejected by the pinhole simultaneously. Consequently, the imaging system can generate both confocal microscope images and scanning laser microscope images at the same time. This dual imaging mode is valuable for imaging samples that produce weak fluorescence signals, including samples with endogenous fluorophores having lower quantum yields than engineered fluorophores, low fluorophore concentrations, or those undergoing photobleaching or fluorescence quenching conditions.

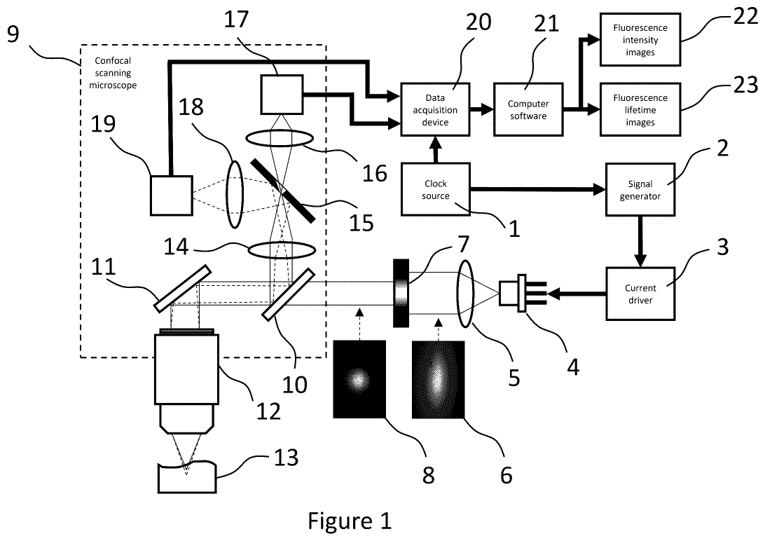

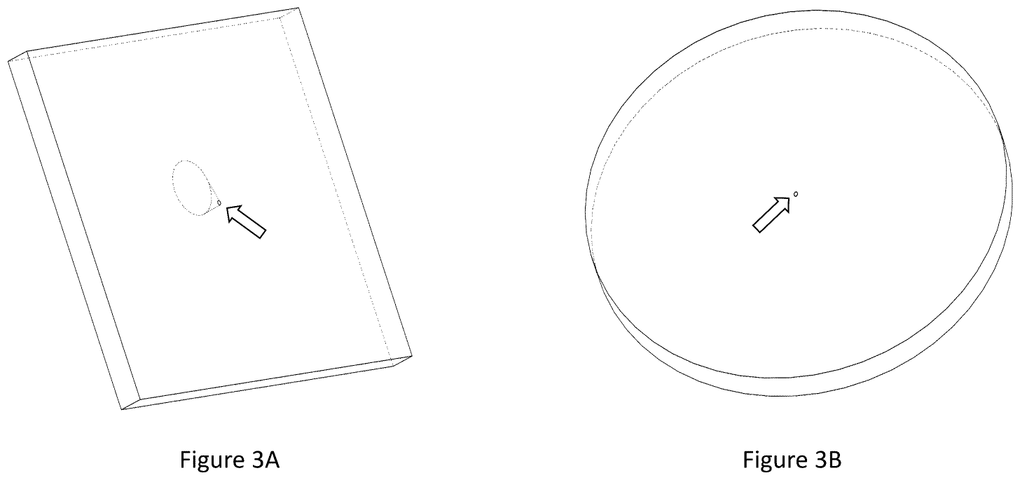

In one embodiment of a fluorescence lifetime imaging microscope, as shown in FIG. 1, a clock source 1 is a crystal oscillator that generates clock pulses as the timing reference for the system. The generated clock pulses have an output voltage range from 10 mV to 10V and a frequency range from 1 MHz to 1 GHz. A signal generator 2, clocked by the clock source 1, generates a repeating waveform with a frequency in the range of 10 MHz to 500 MHz. Based on the waveform data stored in the signal generator's memory, the waveform can be either a pulse or a sinusoidal shape. A diode laser 4 is driven by its current driver 3, modulated by the waveform with modulation depth larger than 90%, and outputs a laser beam with an elliptical shape 6 after passing through a collimation lens 5. A spatial beam attenuator 7 provides non-uniform attenuation of the laser beam, converting the elliptical beam shape 6 into a circular beam with Gaussian intensity profile 8. A confocal fluorescence microscope 9 accepts the Gaussian-shaped beam 8 and scans the laser beam using a beam scanner 11 behind an objective lens 12. A sample 13 produces fluorescence signals when scanned by the laser beam focused by the objective. The fluorescence signals are collected by the same objective lens 12 and separated from the excitation beam by a dichroic filter 10. Focused by a lens 14, the fluorescence signals are split by a transmission-type pinhole beam splitter 15 into two detection channels. The transmission-type pinhole beam splitter 15 has a mirrored surface surrounding a centered pinhole that is transparent to the beam. When oriented at 45 degrees relative to the incoming focused beam, the pinhole beam splitter uses the centered pinhole to pass signals originating from the sample focal plane, collected by lens 16 and detector 17 in the first channel; and uses the mirrored surfaces surrounding the pinhole to reflect all signals originating from out-of-focus planes to another direction, collected by lens 18 and detector 19 in the second channel. The output signals from the two detectors 17 and 19 are digitized by a data acquisition device 20, which is clocked by the master clock from clock source 1. The digitized fluorescence signals are processed by software 21 to extract intensity, phase, and modulation information at the modulation frequency of the excitation laser. The intensity information is used to construct the fluorescence intensity images 22, while the phase and modulation information are used to construct the fluorescence lifetime images 23. The transmission-type pinhole beam splitter is manufactured by drilling a small hole on a mirror from its back side at 45 degrees, using laser drilling or other precision drilling methods. An example of the manufactured transmission-type pinhole beam splitter is illustrated in FIG. 3A, with the arrow indicating the incoming focused beam. Alternatively, the transmission-type pinhole beam splitter can be manufactured by first drilling a small hole in the substrate at a 45-degree angle from the back. The front surface is then polished to optical mirror quality, and after the drilled hole is cleaned, a reflective coating is applied to the polished surface to complete the process. The pinhole diameter of the pinhole beam splitter is between 1 μm and 100 μm, and the pinhole is positioned in the depth-of-focus region of an incoming focused beam.

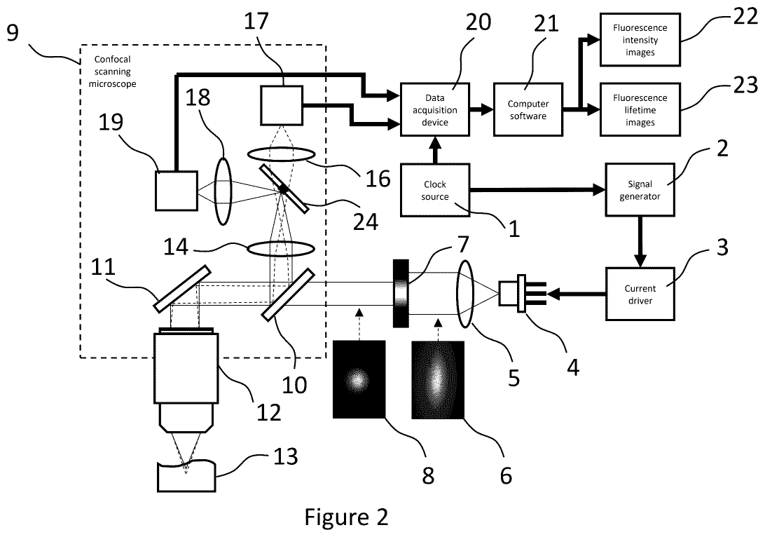

In one embodiment of the FLIM system shown in FIG. 2, the configuration is nearly identical to FIG. 1, except that the pinhole beam splitter 24 is of the reflection type. The reflection-type pinhole beam splitter 24 features a highly reflective center region the size of an optical pinhole, with the surrounding region being transparent. When oriented at 45 degrees relative to the incoming focused beam, the pinhole beam splitter uses the center pinhole reflector to reflect signals originating from the sample focal plane in one direction, which are then collected by lens 18 and detector 19. It allows signals originating from out-of-focus planes to pass through the transparent regions surrounding the center pinhole reflector to be collected by lens 16 and detector 17. The reflection-type pinhole beam splitter can be manufactured by depositing a mask with an opening the size of a pinhole onto a polished and transparent optical substrate. The mask covers the transparent optical substrate before a highly reflective layer is coated onto it. After the coating process, the mask is removed, leaving a pinhole-sized mirror on the transparent substrate. For a pinhole beam splitter oriented at 45 degrees relative to the incoming focused beam, an elliptical-shaped mask is needed. An example of the manufactured reflection-type pinhole beam splitter is illustrated in FIG. 3B, with the arrow indicating the incoming focused beam. The device has a small reflective pinhole region in the center, while the surrounding area is optically transparent.

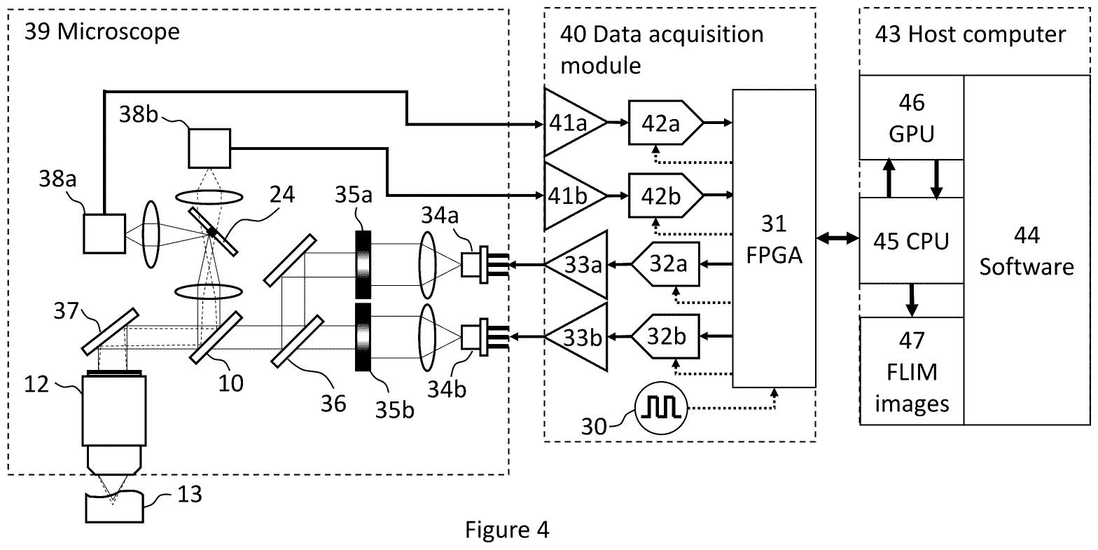

In one embodiment of the FLIM system shown in FIG. 4, within a data acquisition module 40, a clock source 30 consisting of a MEMS oscillator supplies a 150 MHz clock to a Field Programmable Gate Array (FPGA) chip 31. The FPGA's phase lock loop synthesizer processes this clock and generates multiple clock signals with fixed phase relationships. These signals are distributed to digital-to-analog converters (DAC 32a and DAC 32b) and analog-to-digital converters (ADC 42a and ADC 42b), all interfacing with FPGA 31. DAC 32a and DAC 32b produce sinusoidal modulation waveforms at 42.1875 MHz and 46.8750 MHz respectively, defined by the waveform data stored in the FPGA's on-chip memory. These waveforms modulate two diode lasers, 34a at 405 nm and 34b at 520 nm, each driven by their respective current amplifiers, 33a and 33b, with a modulation depth exceeding 95%. The outputs from these lasers are shaped into beams with Gaussian intensity profiles by custom spatial beam attenuators 35a and 35b, combined into a single beam path by a dichroic filter 36, and directed toward an optical scan-head 37 featuring XY galvanometer scanners positioned near the objective lens's back aperture 12. Fluorescence emissions from the sample 13 at the objective's focal plane are collected by the same objective. A dichroic filter 10 allows the excitation wavelengths to pass while reflecting fluorescent emissions toward a reflection-type pinhole beam splitter 24 with a 10 μm diameter pinhole. Fluorescence photons arriving within the pinhole's radius are captured by photomultiplier tube 38a in reflection mode, while those arriving outside the pinhole's radius are collected by another photomultiplier tube 38b in transmission mode. The signals from these photomultiplier tubes are amplified by transimpedance amplifiers 41a and 41b, digitized by ADC 42a and ADC 42b, and stored as time series data in the FPGA's on-chip memory. This data is then transferred to a host PC 43 via communication mechanisms between the FPGA and CPU, such as a PCI Express bus or a USB cable. Software 44 running on the host PC processes this data using its CPU 45 and GPU 46 to construct FLIM images 47. Images constructed using the data from ADC 42a are confocal FLIM images, while those constructed using combined data from ADC 42a and ADC 42b are laser scanning FLIM images. The fluorescence signals excited by the two different lasers are frequency encoded and are differentiated using Fast Fourier Transform (FFT) of the time series data.

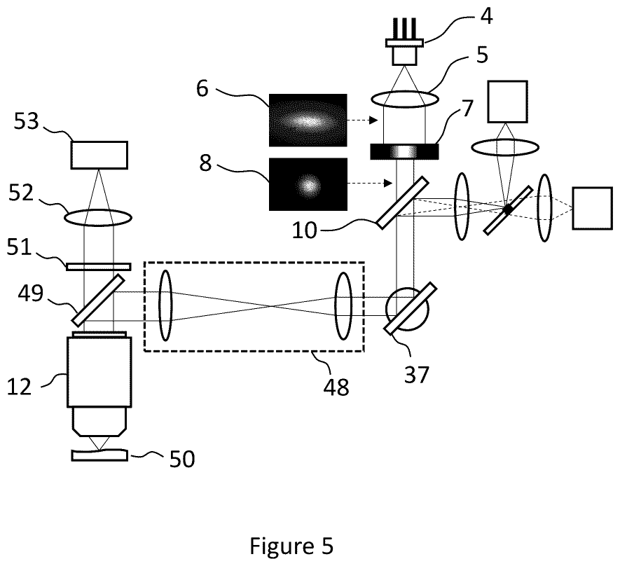

In one embodiment of the FLIM system illustrated in FIG. 5, the microscope's design resembles that shown in FIG. 2, with the addition of a pair of relay lenses 48 and a dichroic beam splitter 49 positioned between the beam scanner 37 and the objective lens 12. The relay lenses 48 form a 4f optical system between the scanner and the objective lens, optically relaying the pivot position of the scanning beam from the scanning axis of the beam scanner to the back aperture entrance of the objective lens. This arrangement enables a larger field of view and a flatter focal plane in the sample. The dichroic filter 49 reflects light with wavelengths shorter than about 750 nm and transmits wavelengths longer than about 750 nm. Another short-wavelength blocking filter 51 is used after the dichroic filter 49 to further block the shorter wavelengths. A tube lens 52 and a camera 53 are used to capture microscopic images after filter 51. Adding the long-pass dichroic filter 49 before the imaging objective 12 enables additional imaging functions, including simultaneous microscopic imaging of the sample and the capability to add another optical beam for excitation and manipulation of the sample.

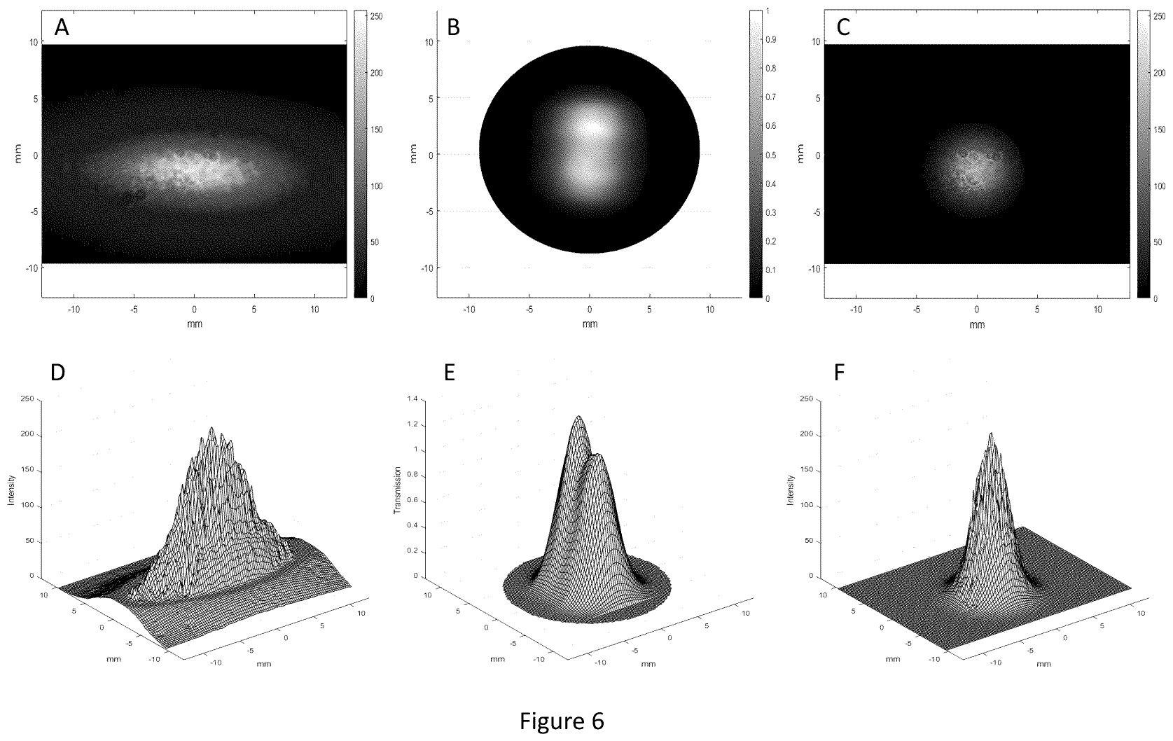

In one embodiment of the FLIM system as shown in FIG. 5, a 405 nm laser diode 4 is used as the excitation source. The laser diode output beam is collimated by a lens 5 into an elliptical beam 6. The cross-sectional intensity profile I(x, y)_{beam} of the elliptic beam 6 is measured using a camera beam profiler separately as shown in FIG. 6A. The spatial beam attenuator 7 with non-uniform 2D attenuation function as shown in FIG. 6B is used to convert the elliptic beam 6 into a circular beam 8 with Gaussian intensity profile I(x, y)_{Gaussian} measured using the camera beam profiler as shown in FIG. 6C.

The beam intensity profile describes the variation of light intensity across the cross-section of a beam. In FIG. 6A, the beam waist ω₀ along the short axis of the elliptic beam can be calculated from the curve fitting of the measured intensity profile as the radius at which the intensity of the Gaussian beam drops to 1/e² (about 13.5%) of its peak intensity. The intensity profile G(x, y) of a target circular Gaussian beam with the same beam waist ω₀ in the transverse plane can be mathematically described as:

$${I ( x , y )}_{Gaussian} = {I}_{0} exp ( - \frac{2 ( {x}^{2} + {y}^{2} )}{{ω}_{0}^{2}} )$$

where I₀ is the peak intensity at the center of the beam. x and y are the spatial coordinates in the transverse plane.

The Beam Transfer Function BTF(x, y) is a 2D spatial function that converts the spatial intensity distribution of an input optical beam from one set of values to another. This process involves altering the shape and scaling of the input beam intensity profile to generate a new beam intensity profile required for a specific application. Since the input beam intensity profile is often measured numerically using an optical beam profiler, the output beam intensity profile is also numerically modeled or converted from a mathematical model to a numerical model for calculation.

For a spatial beam attenuator designed to generate a circular Gaussian beam as the output, BTF(x, y) is given by:

$$BTF ( x , y ) = \frac{{I ( x , y )}_{Gaussian}}{{I ( x , y )}_{beam}} = \frac{{I}_{0} exp ( - \frac{2 ( {x}^{2} + {y}^{2} )}{{ω}_{0}^{2}} )}{{I ( x , y )}_{beam}}$$

BTF(x, y) is usually self-normalized to the maximum value within the beam waist.

$${BTF}_{N} ( x , y ) = \frac{BTF ( x , y )}{{max}_{x , y} T ( x , y )}$$

A 2D mean filter is also used to remove some high frequency noise.

$${BTF}_{NF} ( x , y ) = \frac{1}{{n}^{2}} {\sum }_{u = x - \frac{n - 1}{2}}^{x + \frac{n - 1}{2}} {\sum }_{v = y - \frac{n - 1}{2}}^{y + \frac{n - 1}{2}} {BTF}_{N} ( u , v )$$

where n is the averaging window size, BTF_{N}(u, v) represents the pixel values in the original 2D function centered at (x, y). BTF_{NF}(x, y) is the final beam transfer function to be manufactured to the spatial beam attenuator. The spatial beam attenuator works in either transmission mode or reflection mode in an optical system.

FIG. 6A shows the intensity profile of the collimated beam from a laser diode measured using a beam profiler.

FIG. 6B shows the beam transfer function BTF(x, y) of the designed spatial beam attenuator for the collimated beam in FIG. 6A. When the center of the spatial beam attenuator is aligned with the center of the elliptically shaped laser beam in FIG. 6A, a new intensity profile that closely approximates a circular Gaussian shape is generated, as shown in FIG. 6C. The optical insertion loss of the spatial beam attenuator, measured as the ratio of total optical power before and after the element, is less than 3 dB, indicating that more than 50% of the original laser power is conserved. Although the insertion loss of this spatial beam attenuator may not be ideal for high-power optical applications, it is acceptable for optical fluorescence imaging applications, where the excitation laser power often needs to be attenuated to avoid photobleaching and reduce phototoxicity in biological samples.

FIG. 6D shows the pseudo 3D profile of the measured beam profile before the spatial beam attenuator, corresponding to FIG. 6A.

FIG. 6E shows the pseudo 3D profile of the beam transfer function of the spatial beam attenuator, corresponding to FIG. 6B.

FIG. 6F shows the pseudo 3D profile of the measured Gaussian beam profile after the spatial beam attenuator, corresponding to FIG. 6C.

Ideally, the beam transfer function of the spatial beam attenuator is customized for each laser. However, for laser diodes of the same type and from the same production batch, the beam characteristics are similar and can share the same spatial beam attenuator design.

The optical alignment of the spatial beam attenuator to the incoming laser beam is performed by aligning the center of the spatial beam attenuator with the peak intensity position of the laser beam and rotating the attenuator so that its long axis aligns with the short axis of the elliptical incoming beam. The spatial beam attenuator is usually oriented at a slight angle of a few degrees to avoid back reflection towards the incoming laser beam.

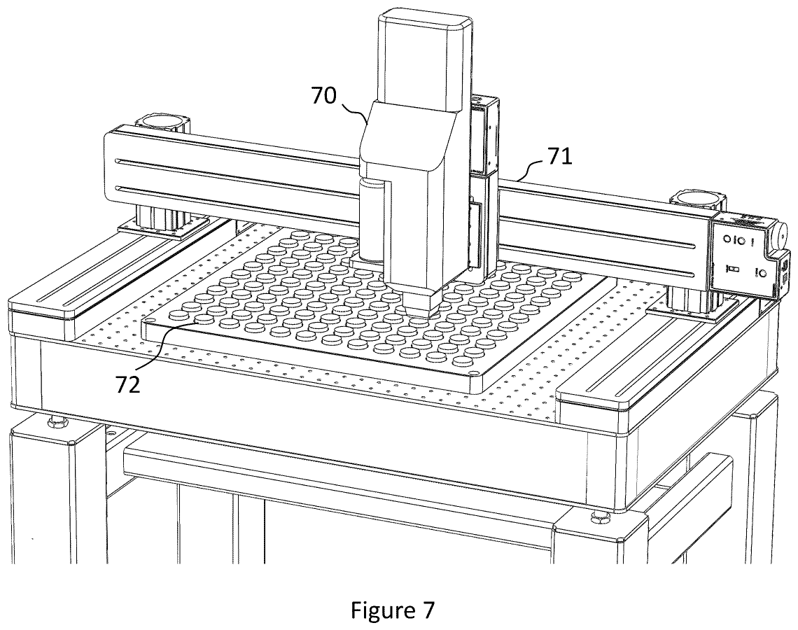

In one embodiment for manufacturing spatial beam attenuators in quantity, as shown in FIG. 7, a flat-bed printer is constructed using an ink-jet print head 70 installed on an XYZ gantry setup 71. The printing head 70 employs metal nanoparticles ink or metal-organic decomposition ink, such as Sigma-Aldrich's high-resolution silver nanoparticle ink 901083. The optical substrates 72 to be printed on are polished optical blanks arranged in an array under the printing head. The precise amount of metallic ink is expelled from the nozzle onto the optical substrates positioned beneath the printing head. The local optical transparency depends on the thickness and density of the deposited metal layer. Varying the number of ink droplets or their spatial distribution density allows the creation of different shades of gray in different regions on a substrate. After a 2D grayscale pattern defined by the beam transfer function is printed onto every substrate, heat treatment or chemical processes can be employed to convert the ink into a solid metal layer that is permanently attached to the substrate.

In one embodiment for manufacturing spatial beam attenuators in quantity, as shown in FIG. 7, a flat-bed printer is constructed using a UV print head 70 installed on an XYZ gantry setup 71. The optical substrates 72 to be printed on are polished optical blanks arranged in an array under the printing head. The printing head 70 has a nozzle to deposit UV-curable ink accurately onto the glass substrates. Varying the number of black ink droplets allows the creation of different shades of gray in different regions on a substrate. An ultraviolet light source in the print head is used to cure the UV ink droplets immediately after their deposition onto the glass, and a 2D grayscale pattern defined by the beam transfer function is printed onto each substrate.

To manufacture spatial beam attenuators designed to work in transmission mode, the optical substrates used in above printing processes are polished transparent glass windows. To manufacture spatial beam attenuators designed to work in reflection mode, the optical substrates used in the printing processes are polished mirrors.

The spatial beam attenuator is designed to operate effectively with lasers that maintain a consistently stable beam intensity profile, a condition met by many laser diodes used in confocal fluorescence microscopy across varying driving currents and operating temperatures. The optical transmission characteristics of the attenuator are tailored to match the calculated beam transfer function, which converts the laser's intensity distribution profile into a circular Gaussian profile. This BTF is embedded into the attenuator's optical characteristics using a printing method and is permanently fixed. A regular fixed-value optical attenuator is often employed for adjusting the total output power of the laser as needed. Both the spatial beam attenuator and the fixed-value optical attenuator can be integrated into a single device, manufactured using the same printing method at the same time.

Accurate calibration of fluorescence lifetime measurements in a FLIM system is essential as it corrects for system-specific factors, such as the instrument response function (IRF), intrinsic signal delays, detector characteristics, and environmental conditions. This ensures that the observed lifetimes accurately reflect the sample's properties. Precise calibration is crucial in applications like FRET studies or cellular dynamics investigations, where distinguishing subtle variations in molecular interactions or environmental conditions is necessary. Calibration aligns acquired data with known standards or reference fluorophores, enabling quantitative interpretation of fluorescence decay curves and reliable lifetime measurements. It also ensures comparability across different systems and laboratories, providing quantitative and reproducible results in diverse scientific fields, from biology to materials science.

Typically, the calibration process involves measuring dyes of calibration standards like coumarin-6 and fluorescein, which requires special tools and sample preparation skills. In an embodiment of the FLIM system shown in FIG. 5, a simplified method is used for FD-FLIM system calibration. In this system, an optical reflector 52 with high reflectivity at the excitation laser wavelength is placed at the focal plane of the objective lens 12 to replace the sample. The optical reflector does not generate fluorescence signals when excited by the laser; however, due to the imperfection of the optical filters in the system, a small number of photons at the excitation wavelength can leak through the filters and reach the detectors. Since these leaked excitation photons follow the same optical path as the fluorescence signal photons, they are treated as originating from a fluorescence sample with a lifetime of 0.0 ns. This enables the calibration of the total time delay experienced by the fluorescence signal photons within the system. Compared to the fluorescence lifetime, which is the average duration a fluorophore remains in the excited state before transitioning to the ground state by emitting a photon, the optical reflection process is instantaneous. Therefore, the optical reflector is deemed as a fluorescence sample of 0.0 ns lifetime and can serve as a calibration device for the FLIM system.

The processing of the time series data of the fluorescence emission signals recorded by the detectors to obtain the sample fluorescence lifetime is described below.

Typically implemented by the Fast Fourier Transform (FFT) algorithm, the discrete Fourier transform of the signals u(t) from a detector can be written as:

$$u ( t ) = {A}_{0} + {\sum }_{n = 1}^{N - 1} {A}_{n} cos ( {ω}_{n} t - {ϕ}_{n} )$$

where A₀ is the signal amplitude at DC; Aₙ and φₙ are the amplitude and phase angle of the n'th frequency component:

$${A}_{n} = \sqrt{{a}_{n}^{2} + {b}_{n}^{2}}$$

$${ϕ}_{n} = arctan ( \frac{{b}_{n}}{{a}_{n}} )$$

Here, aₙ=Aₙ cos φₙ and bₙ=Aₙ sin φₙ are the real and imaginary parts of the n'th frequency components in the output of the FFT. ωₙ is the angular frequency of the n'th frequency component and N is the half value of the FFT window length.

$${ω}_{n} = 2 π {f}_{n} = π n \frac{{f}_{clk}}{N}$$

where f_{clk} is the sampling frequency of the A/D converter.

The intensity of the excitation light modulated at an angular frequency ωₖ can be written as:

$${I}_{ex} ( t ) = {I}_{{ex}_{k}} [ \frac{1}{2} + \frac{1}{2} cos ( {ω}_{k} t + {ϕ}_{{ex}_{k}} ) ]$$

where Iₑₓ_{ₖ} is the maximum excitation intensity of the laser with an initial phase of φₑₓ_{ₖ}. The intensity of the fluorescence emission signals can then be written as

$${I}_{em} ( t ) = {I}_{{em}_{k}} [ \frac{1}{2 m} + \frac{1}{2} cos ( {ω}_{k} t + {ϕ}_{{em}_{k}} ) ]$$

where Iₑₘ_{ₖ} is the measured amplitude of the fluorescence intensity and φₑₘ_{ₖ} is the measured phase. m is the relative modulation depth between emission and excitation and corresponds to the reduction of modulation depth of the fluorescence emission compared to the excitation because m<1.

The sample's fluorescence lifetime can be calculated from the measure phase information using:

$${τ}_{ϕ} = \frac{1}{ω} tan ( {ϕ}_{sample} ) = \frac{1}{{ω}_{k}} tan [ {ϕ}_{{em}_{k}} - ( {ϕ}_{{ex}_{k} +} {ϕ}_{{sys}_{k}} ) ] = \frac{1}{{ω}_{k}} tan ( {ϕ}_{{em}_{k}} - {ϕ}_{{cal}_{k}} )$$

where φₛₐₘₚₗₑ is the phase shift truly related to the sample fluorescence lifetime, φ_{cal}_{ₖ} is the phase calibration factor for the k′th laser defined as the sum of the initial laser excitation phase φₑₓ_{ₖ} and a system related phase shift φ_{sys}_{ₖ} which is caused by the time delay the signals experienced in both the optical path and the electrical path of the system.

It is found that when an optical reflector such as a mirror is placed at the focal plane of the objective lens to replace the sample, and sufficient directly reflected photons collected by the objective lens can leak through the filters to reach the detectors, the phase calibration factor φ_{cal}_{ₖ} can be obtained using:

$${ϕ}_{{cal}_{k}} = {ϕ}_{{em}_{k}}^{mirror}$$

The sample's fluorescent lifetime can also be calculated from the measure modulation depth information using:

$${τ}_{m} = \frac{1}{ω} \sqrt{\frac{1}{{m}^{2}} - 1} = \frac{1}{{ω}_{k}} \sqrt{\frac{1}{{( {C}_{k} \cdot \frac{{A}_{{em}_{k}}}{{A}_{{em}_{0}}} )}^{2}} - 1}$$

where m is the ratio of modulation depth between the excitation and emission, Aₑₘ_{₀} is the fluorescence emission signal amplitude measured at DC, Aₑₘ_{ₖ} is the fluorescence emission signal amplitude measured at the modulation frequency of the k′th laser. Cₖ is the constant to be calibrated for the k′th laser.

When an optical reflector such as a mirror is used as the calibration sample of τₘ=0, the calibration constant Cₖ can be obtained using:

$${C}_{k} = \frac{{A}_{{em}_{0}}^{Mirror}}{{A}_{{em}_{k}}^{Mirror}}$$

Therefore, the calibration factors of φ_{cal}_{ₖ} and Cₖ can be measured directly in the system when an optical reflector is used as the sample and placed at the focusing plane of the objective lens. A complete calibration process requires the measurement of Cₖ at different laser driving conditions of current and temperature settings, and different gain settings of the detectors and amplifiers, because all these settings impact the system-introduced time delay to the measured signals.

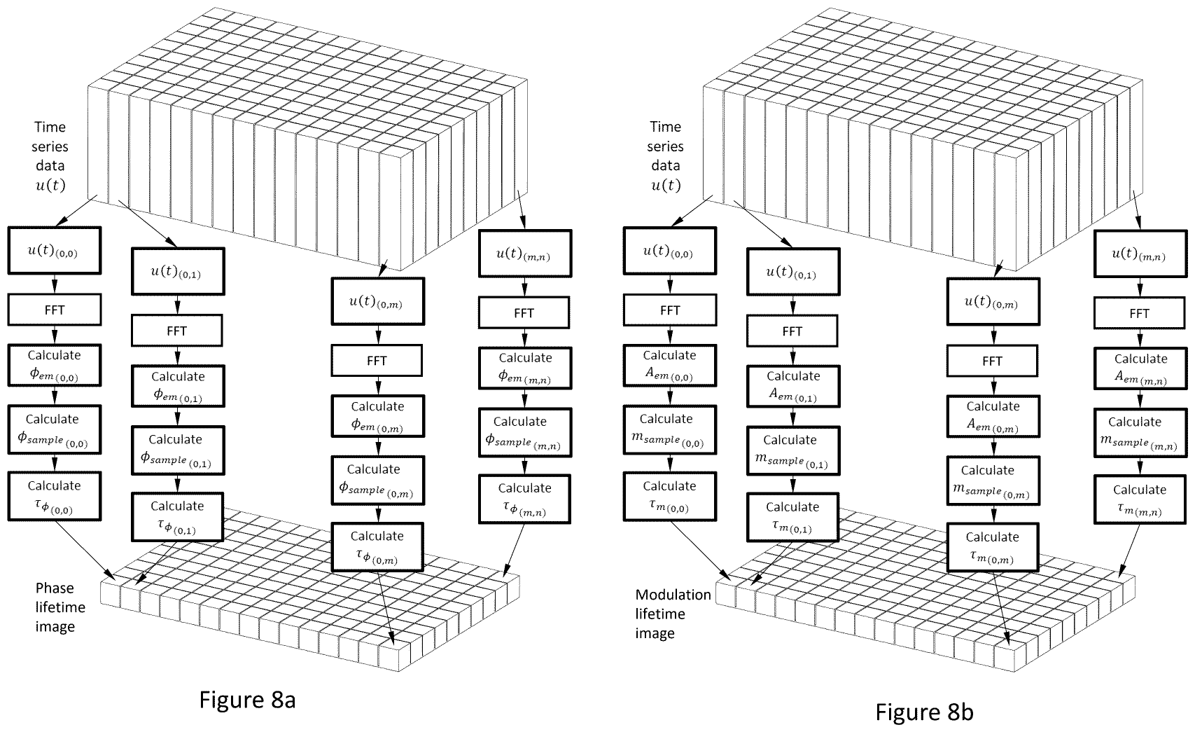

In an embodiment of the FLIM system depicted in FIG. 8, FLIM image construction algorithms are parallelized and accelerated using Graphics Processing Units (GPUs). Because each pixel's data is independent, the image construction process benefits tremendously from the parallel processing capabilities of GPUs. In frequency domain FLIM, the Fast Fourier Transform (FFT) is the primary mathematical tool for data processing. The FFT transforms the signal from the time domain to its frequency domain representation, providing amplitude and phase information across all frequencies simultaneously. When the laser modulation is switched from a pure sinusoidal waveform to a pulse waveform, the resulting amplitude and phase at the laser modulation fundamental and harmonics are available to create multi-frequency analysis plots. These plots have the modulation frequency on the x-axis, and dual Y-axes displaying the phase angle and modulation ratio. Such plots are useful in distinguishing multiple fluorophores with distinct lifetimes. The phase lifetime in FLIM is determined by the phase shift between the excitation and emission signals at any given frequency, while the modulation ratio lifetime is calculated from the ratio of the amplitude at the specific frequency to that at a low frequency or DC. The raw data from the data acquisition device (DAQ) are organized into data records, with each record containing the time series data for a single pixel. These records are then transferred to the GPU's device memory for further processing.

In one example of the parallel processing of FLIM images using the phase method as shown in FIG. 8a, the task to measure one pixel in an image includes the following steps:
1. Performing Fourier transform of the fluorescence emission signals recorded as time series data u(t)_{(m,n)} at one pixel (m, n) in an image;
2. Calculating the phase φₑₘ_{_{(m, n)}} of the fluorescence emission signals at the pixel (m, n);
3. Calculating the sample induced phase shift φₛₐₘₚₗₑ_{_{(m,n)}} at the pixel;
4. Calculating the phase lifetime τ_{φ}_{_{(m,n)}} at the pixel.

In another example of the parallel processing of FLIM images using the modulation ratio method as shown in FIG. 8b, the task to measure one pixel in an image includes the following steps:
1. Performing Fourier transform of the fluorescence emission signals recorded as time series data u(t)_{(m,n)} at one pixel (m, n) in an image;
2. Calculating the amplitude Aₑₘ_{_{(m,n)}} of the fluorescence emission signals at the pixel (m, n);
3. Calculating the sample induced modulation ratio mₛₐₘₚₗₑ_{_{(m,n)}} at the pixel;
4. Calculating the phase lifetime Tₘ_{_{(m,n)}} at the pixel.

To construct a lifetime image with m pixels by n pixels using either the phase lifetime or modulation lifetime method, a total of m×n tasks, similar to described above, are needed. This large number of tasks is carried out on a GPU by the thousands of processing cores that can execute simultaneously, significantly reducing the total processing time. Please note that FIG. 8a and FIG. 8b demonstrate the calculation of phase and modulation lifetime at a single frequency of interest. It is possible to calculate this information at multiple frequencies of interest, including the fundamental and harmonic frequencies of the laser modulation, by utilizing the FFT output across all frequencies.

In conventional GPU-aided image data acquisition and processing, a frequent bottleneck is the extensive data transfers required between different memory spaces. Typically, data moves from the onboard memory of the DAQ to the system memory of the host computer, and then to the GPU's device memory for parallel processing. After processing, the results are transferred back to the host computer. These frequent transfers of large volumes of data across multiple memory spaces can significantly increase latency and bandwidth constraints. The CPU often manages these transfers including performing memory copy operations, which add processing overhead and slow down the system. Data congestion may occur due to numerous simultaneous memory and I/O access requests, further reducing data flow efficiency.

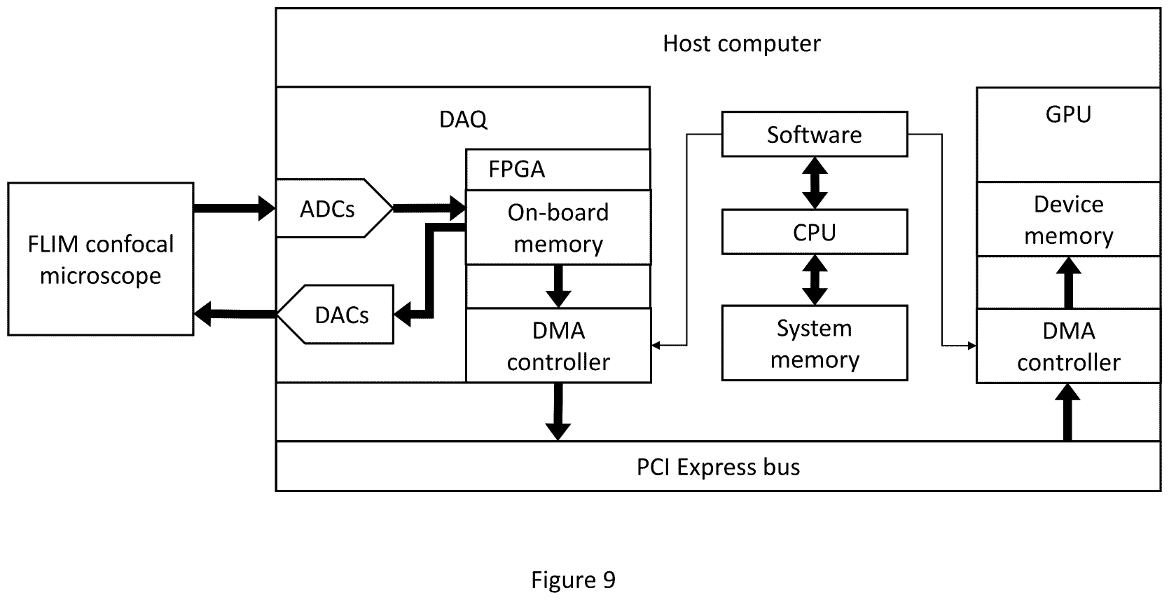

In an embodiment of the FLIM system shown in FIG. 9, the DAQ includes an FPGA that interfaces with ADCs and DACs. The FLIM confocal microscope communicates with the DAQ by receiving laser modulation waveforms from the DACs and transmitting detector signals to the ADCs. The detector signals are converted into time series data by the ADCs and stored in the DAQ's onboard memory which is an external memory to the FPGA or the FPGA's on-chip memory. The FPGA also incorporates a PCI-express interface and a DMA controller in its design. Because both the DAQ and the GPU are connected to the same PCI Express data bus in the host computer, the CPU programs the DMA controller on the DAQ to transfer memory data directly from the DAQ's onboard memory to the GPU's device memory via the PCI Express bus. This data path bypasses the host computer's system memory, significantly reducing latency and CPU overhead, thereby improving data transfer efficiency and the overall framerate of the imaging system.

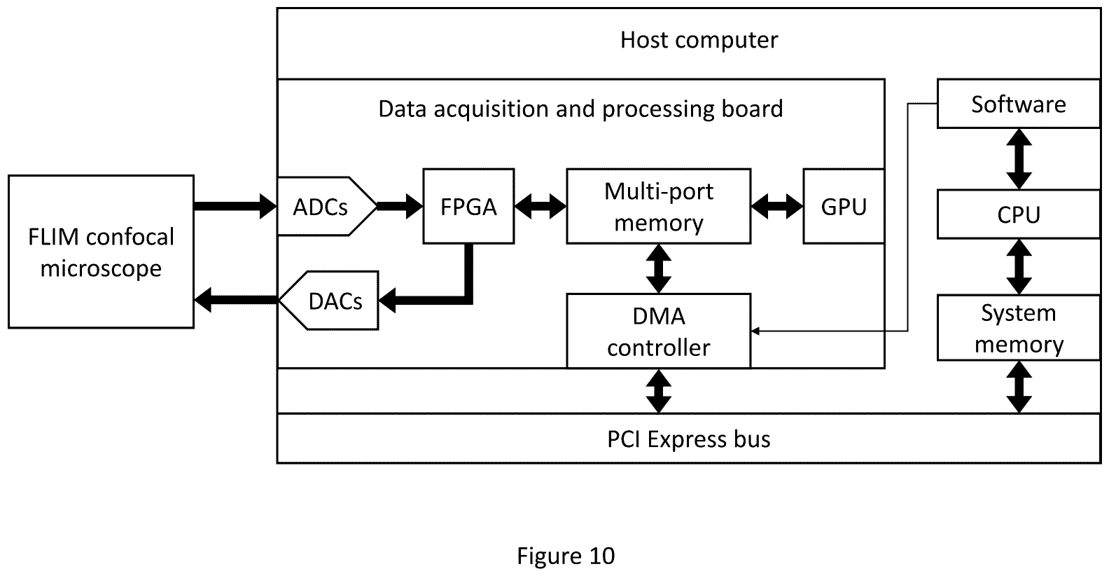

In an embodiment of the FLIM system depicted in FIG. 10, a data acquisition and processing board is installed on the PCI Express bus of a host computer. The board features an FPGA and a GPU that share a multi-port memory, along with a DMA controller. The FPGA interfaces with the ADCs and DACs that communicate with the FLIM confocal microscope. The multi-port memory allows simultaneous read and write operations through its multiple ports. Once the FPGA stores the converted time series data in the shared memory via the first port, the GPU begins processing the data using the second port and stores the processed data back in the shared memory. The software running on the CPU of the host computer programs the DMA controller to transfer the processed data to the host computer's system memory for further processing and display. This design integrates the FPGA and GPU on a single board with shared memory, eliminating the need to transfer large amounts of data between different memory spaces. Consequently, both the data processing efficiency and the framerate of the imaging system are maximized in this configuration.

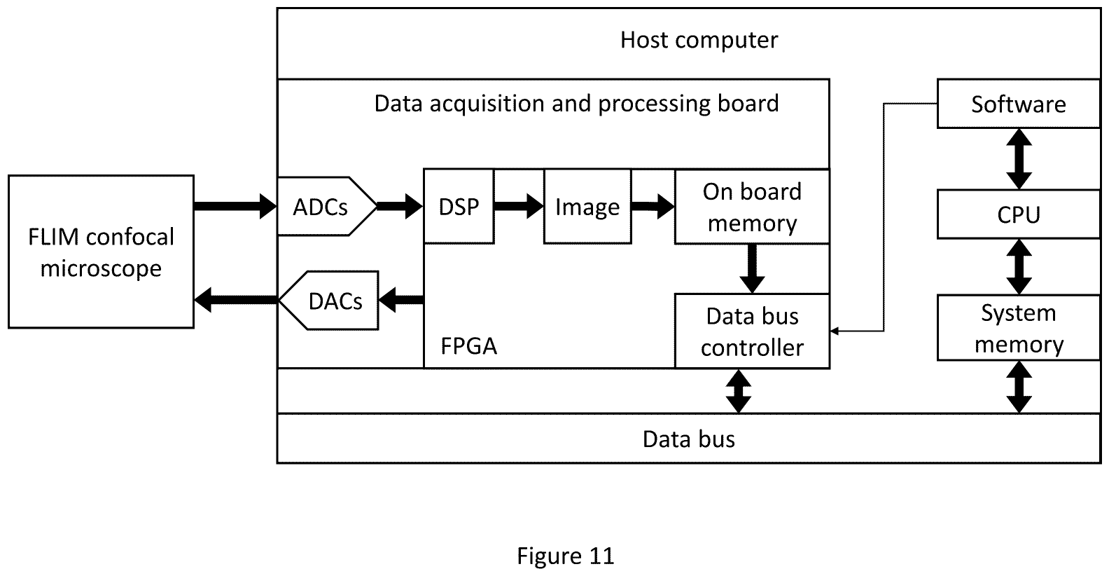

In an embodiment of the FLIM system shown in FIG. 11, a data acquisition and processing board is equipped with a high-performance FPGA that possesses data processing capabilities. This FPGA interfaces with the ADCs and DACs communicating with the FLIM confocal microscope. The ADCs convert the output signals from the microscope's detectors into time series data. This data is then processed by a DSP module within the FPGA, which performs Fast Fourier Transforms and calculates intensity, phase, and modulation ratio at the laser modulation fundamental and harmonic frequencies. The results of these calculations are stored in the onboard memory, which could be the FPGA's on-chip memory or an external memory chip accessible to the FPGA. A data bus controller manages the transfer of the processed results via the data bus to the system memory of the host computer. The software running on the host computer further processes these results and displays them as FLIM images. In one specific example of this embodiment, the data bus is Universal Serial Bus (USB), and the data bus controller is a SuperSpeed USB3.0 IC, such as the FT600Q chip from FTDI. This configuration leverages the FPGA for both data acquisition and parallel data processing tasks without the use of a GPU, potentially offering a cost-effective solution in FLIM imaging applications.

1. A system for optical fluorescence imaging comprising:
A clock source, wherein the clock source serves as the timing reference in the system;
A waveform generator, wherein the waveform generator generates a waveform clocked by the clock source;
An intensity-modulated laser, wherein the output intensity of the laser is modulated by the waveform generated by the waveform generator. Additionally, the laser wavelength is chosen to match the absorption band of the fluorophores in the sample to be imaged;
A spatial beam attenuator, wherein the spatial beam attenuator converts the output beam of the laser into a circular beam with Gaussian intensity profile for sample illumination;
A confocal laser scanning fluorescence microscope, wherein the microscope uses a pinhole beam splitter to simultaneously record the fluorescence signals accepted by the pinhole and the signals rejected by the same pinhole into time series data using different detectors;
A data acquisition device, wherein the device performs analog-to-digital conversion of the time series data. This data conversion process is clocked by the same clock source; and
A computer software, wherein the software controls the acquisition and processing of the time series of data, calculates the fluorescence lifetime, and displays the images of the sample.

2. The system for optical fluorescence imaging of claim 1, wherein the clock source is a crystal oscillator, or a MEMS oscillator, or the output of a phase-locked loop synthesizer. The clock source has an output frequency range from 1 MHz to 1 GHz, and an output voltage range from 10 mV to 10 V.

3. The system for optical fluorescence imaging of claim 1, wherein the signal generator repeatedly generates an analog waveform defined by data stored in a memory, and wherein the digital-to-analog conversion of this waveform is synchronized with the clock source.

4. The system for optical fluorescence imaging of claim 1, wherein the intensity-modulated laser produces a free space output beam, and the laser output is modulated in a frequency range from 10 MHz to 500 MHz with a modulation depth greater than 90%. The intensity-modulated laser is a directly modulated laser, such as a current-modulated diode laser, or an externally modulated laser, or a mode-locked laser.

5. The system for optical fluorescence imaging of claim 1, wherein the spatial beam attenuator provides non-uniform attenuation of the incoming optical beam, and converts the incoming beam into a circular beam with Gaussian intensity profile. The spatial beam attenuator works in either transmission mode or reflection mode.

6. The system for optical fluorescence imaging of claim 1, wherein the spatial beam attenuator has customized optical transmission characteristics to match the designed beam transfer function (BTF). The BTF is specifically designed to convert a beam with any intensity profile into a circular beam with Gaussian intensity profile. The BTF is manufactured into the component's optical transmission characteristics using a printing method and is subsequently fixed.

7. The system for optical fluorescence imaging of claim 6, wherein the customization of the optical transmission characteristics of the spatial beam attenuator is realized in a digital printing process by locally varying the thickness of a thin optical layer deposited onto an optical substrate, or by locally varying the spatial distribution density of particles deposited onto an optical substrate, or by locally varying the amount of ink droplets deposited onto an optical substrate to be cured in a UV printing process.

8. The system for optical fluorescence imaging of claim 1, wherein the intensity-modulated laser is replaced by multiple intensity-modulated lasers of different wavelengths. Each laser is modulated at a distinct frequency and employs a unique spatial beam attenuator. The output beams from these multiple lasers are optically combined into a single beam using a beam combiner.

9. The system for optical fluorescence imaging of claim 1, wherein the confocal scanning microscope operates in a dual imaging mode by using the pinhole beam splitter to separate the fluorescence signals from the sample into two channels for simultaneous detection. The pinhole diameter of the pinhole beam splitter is between 1 μm and 100 μm, and the pinhole is positioned in the depth-of-focus region of an incoming focused beam. The light within the pinhole radius, which is accepted by the pinhole, is measured by one detector to construct normal confocal images, while the light outside this radius, which is rejected by the pinhole, is collected and measured by another detector to construct scanning laser images by combining the signals from both detectors.

10. The system for optical fluorescence imaging of claim 9, wherein the pinhole beam splitter is of the transmission type. The light accepted by the pinhole passes the device in a transmission mode, while the light rejected by the pinhole passes the device in a reflection mode.

11. The system for optical fluorescence imaging of claim 9, wherein the pinhole beam splitter is of the reflection type. The light accepted by the pinhole passes the device in a reflection mode, and to the light rejected by the pinhole passes the device in a transmission mode.

12. The system for optical fluorescence imaging of claim 1, wherein the data acquisition device converts the analog output signals from the detector into digital data at a conversion rate that is at least twice the frequency of the laser modulation waveform. The analog-to-digital conversion process is synchronized with the same clock source that clocks the digital-to-analog conversion to generate the laser modulation waveform.

13. The system for optical fluorescence imaging of claim 1, wherein the computer software runs on a host computer to process the time series data transferred from the data acquisition device and stored in the host computer's system memory. The software performs a Fourier transform of the digital data to analyze the frequency domain information, including intensity, phase and modulation ratio at the laser modulation fundamental and harmonic frequencies, and calculates the fluorescence lifetime point-by-point across the sample to construct FLIM images.

14. The system for optical fluorescence imaging of claim 1, wherein the computer software has access to the time series data transferred from the data acquisition device. The software transfers this data to a graphics processing unit (GPU) for parallel processing the data related to each image pixel. The processing tasks for each pixel include performing a Fourier transform of the data, measuring intensity, phase, and modulation ratio at the laser modulation fundamental and harmonic frequencies, and calculating the fluorescence lifetime for each pixel. The GPU is configured to execute these processing tasks concurrently for all pixels to construct FLIM images.

15. The system for optical fluorescence imaging of claim 1, wherein the computer software programs the DMA controller on the data acquisition device to directly transfer the time series data from the onboard memory of the data acquisition device to the device memory of the graphics processing unit (GPU), bypassing the host computer's system memory. The GPU is tasked with parallel processing of the data for all pixels to construct FLIM images.

16. The system for optical fluorescence imaging of claim 1, wherein the software running on the host computer programs the DMA controller on a data acquisition and processing board installed in the host computer to transfer the processed images for display. A FPGA on the data acquisition and processing board controls the ADCs and DACs interfacing with the microscope. The FPGA has a shared memory with a GPU residing on the same board. The FPGA stores the time series data in the shared memory. The GPU is tasked with parallel processing of the time series data concurrently for all pixels to construct FLIM images.

17. The system for optical fluorescence imaging of claim 1, wherein the software running on the host computer obtain data from a data acquisition and processing board through a data bus. The FPGA on the data acquisition and processing board performs FFT on the time series data, calculates intensity, phase, and modulation ratio at the laser modulation and harmonic frequencies. The calculated results are transferred to the system memory of the host computer via a data bus controller. The software further processes the transferred data to construct FLIM images.
